(19) United States
(12) Patent Application Publication
(10) Pub. No.: US 2024/0328533 A1
(43) Pub. Date: Oct. 3, 2024

(54) METHOD FOR DETERMINING AN OPENING POINT POSITION VALUE AND VALVE DEVICE

(71) Applicant: Festo SE & Co. KG, Esslingen (DE)

(72) Inventors: Michael BRAUNE, Nürtingen (DE); David RAGER, Nürtingen (DE); Rüdiger Neumann, Ostfildern (DE)

(21) Appl. No.: 18/623,578

(22) Filed: Apr. 1, 2024

(30) Foreign Application Priority Data
Apr. 3, 2023 (DE) 10 2023 108 440.2

(51) Int. Cl. F16K 37/00; F16K 31/00

(52) U.S. Cl. CPC F16K 37/0041; F16K 31/004

(57) ABSTRACT

A method for determining an opening point position value of a valve device with a valve unit, in particular a piezo valve unit, in which the opening point position value describes the position of a valve member of the valve unit at which position the valve member changes from a closed state to an open state. The method including providing a drive variable signal course to drive the valve member with a drive variable so that the valve member is moved from the closed state to the open state and/or from the open state to the closed state, during the provision of the drive variable signal course, recording a position characteristic curve of the valve member as a function of the drive variable, on the basis of the recorded position characteristic curve, determining the opening point position value.

This application claims priority to German Patent Application No. 10 2023 108 440.2 filed Apr. 3, 2023, which is incorporated by reference.

The invention relates to a method for determining an opening point position value of a valve device with a valve unit, in particular a piezo valve unit, wherein the opening point position value describes the position of a valve member of the valve unit at which the valve member changes from a closed state to an open state.

### SUMMARY OF THE INVENTION

One object of the invention is to provide a reliable method for determining the opening point position value.

The object is solved by a method comprising the steps:
providing a drive variable signal course, in particular a drive variable ramp, in order to drive the valve member with a drive variable, in particular an electrical voltage or a pressure, so that the valve member is moved from the closed state to the open state and/or from the open state to the closed state,
recording a position characteristic curve of the valve member as a function of the drive variable during the providing of the drive variable signal course and
on the basis of the recorded position characteristic curve, determining the opening point position value.

The recorded position characteristic curve can be used to identify the position of the valve member at which the valve member changes from the closed state to the open state. This makes it possible to reliably determine the opening point position value.

The providing of the drive variable signal course, the recording of the position characteristic curve and the determining of the opening point position value shall also be referred to together as the opening point determination procedure. Preferably, the valve device carries out the opening point determination procedure repeatedly, for example periodically, in order to determine a current opening point position value in each case. The drive variable may also be referred to as drive quantity.

Ageing of a flexible sealing element (e.g. a sealing pad), temperature influences in the measuring system, the assembly of the valve to the measuring circuit board and/or a floating bearing of the valve member in the valve unit can lead to a change in the actual opening point position value. An opening point variable is expediently stored in the valve device, which opening point variable is intended to represent the actual opening point position value and which opening point variable is expediently used for a closed-loop control performed with the valve unit. If the actual opening point position value changes over time and no longer matches the opening point variable, this can impair the closed-loop control, in particular the closed-loop control quality. For example, it is then possible that a controller executing the closed-loop control assumes the closed state, although the valve unit is actually still in the open state, or that the valve unit is still in the closed state, although the closed-loop control already requests a small valve opening—i.e. the open state. Furthermore, if the opening point variable deviates from the actual opening point position value, it is possible that an actual flow rate through the valve unit differs from a set flow rate. The opening point determination procedure explained above makes it possible to adapt the opening point variable to the actual opening point position value and thus avoid the problems mentioned.

The invention further relates to a valve device. The valve device has a valve unit, in particular a piezo valve unit, which valve unit has a valve member which can be moved from a closed state to an open state by means of a drive variable, in particular an electrical voltage or a pressure, the valve device being configured to provide a drive variable signal course, in particular a drive variable ramp, in order to drive the valve member, so that the valve member is moved from the closed state to the open state and/or from the open state to the closed state, to provide a position characteristic curve of the valve member as a function of the drive variable during the provision of the drive variable signal course and to determine an opening point position value on the basis of the recorded position characteristic curve, the opening point position value describing the position of the valve member at which the valve member changes from the closed state to the open state.

### BRIEF DESCRIPTION OF THE DRAWINGS

Further exemplary details and exemplary embodiments are explained below with reference to the figures. Thereby shows

FIG. 1 a schematic representation of a valve unit,

FIG. 2 a schematic representation of a valve device,

FIG. 3 a block diagram of a control loop,

FIG. 4 a position characteristic curve of a valve member and a rotated position characteristic curve and

FIG. 5 a time curve of a drive variable with a drive variable signal course.

### DETAILED DESCRIPTION OF THE INVENTION

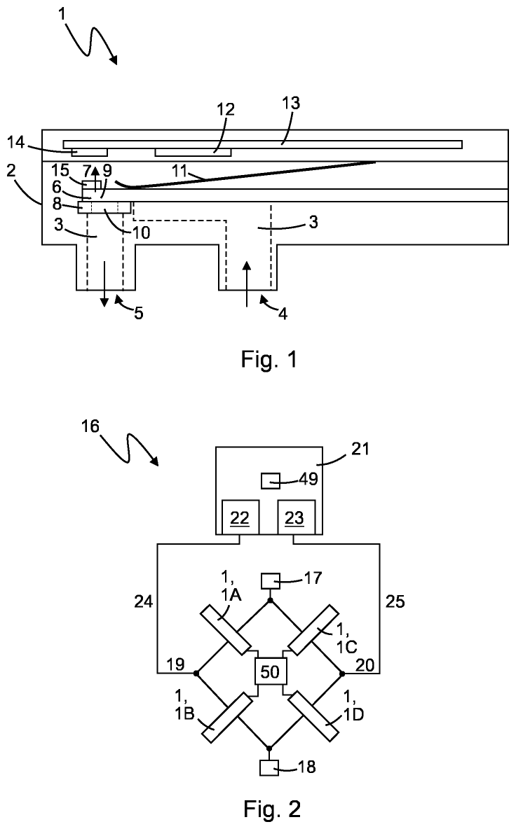

FIG. 1 shows a valve unit 1, which is exemplarily designed as a piezo valve unit. The valve unit 1 has a valve unit housing 2, which is the outer housing of the valve unit 1, for example. The valve unit 1 has a fluid channel 3, which runs in particular inside the valve unit housing 2, exemplarily from a first fluid port 4 to a second fluid port 5 of the valve unit 1. The first fluid port 4 and the second fluid port 5 are expediently arranged on the outside of the valve unit housing 2.

The valve unit 1 has a valve member 6, which can expediently be set selectively to a closed state or an open state. Preferably, the valve unit 1 is a proportional valve. In the closed state, the valve member 6 interrupts the fluid channel 3 so that, in the closed state, fluid is prevented from flowing from the first fluid port 4 to the second fluid port 5 via the fluid channel 3. In the open state, the valve member 6 releases the fluid channel 3 so that fluid can flow from the first fluid port 4 to the second fluid port 5 via the fluid channel 3 in the open state. As an example, the valve member 6 is designed as a piezo bending actuator. According to an alternative embodiment, the valve member is a fluidically, in particular pneumatically, actuated valve member.

In FIG. 1, the valve member 6 is shown in the closed state. By providing a drive variable, for example an electrical voltage, the valve member 6 can be moved from the closed state to the open state. In the example in FIG. 1, the valve member 6 moves in the direction of the arrow marked with the reference sign 7 by applying a corresponding electrical voltage in order to assume the open state.

The valve unit 1 preferably has an elastic sealing element 8. In the closed state, the valve member 6 is in contact with the elastic sealing element 8. Expediently, the valve member 6 is not in contact with the elastic sealing element 8 in the open state. In particular, in the closed state, the valve member 6 rests with a closure section 9 (of the valve member 6) against the elastic sealing element 8 and does not rest with the closure section 9 against the elastic sealing element 8 in the open state. The closure section 9 is expediently arranged at an end of the valve member 6 located in the longitudinal direction of the valve member 6 and expediently interrupts the fluid channel 3 in the closed state. The elastic sealing element 8 is expediently designed with a higher elasticity than the valve member 6 and/or the valve unit housing 2. As an example, the elastic sealing element 8 has a sealing element opening 10 through which the fluid channel 3 runs. In the closed state, the valve member 6 closes the sealing element opening 10 and in the open state, the valve member 6 releases the sealing element opening 10. As an example, the elastic sealing element 8 is designed as a valve seat and/or sealing pad.

As an example, the valve unit 1 further has a spring element 11, which acts on the valve member 6 and, expediently, exerts a force on the valve member 6 in the direction of the closed state.

The valve unit 1 also expediently has a computing unit 12, for example a microcontroller, which is expediently arranged in the valve unit housing 2. As an example, the computing unit 12 is arranged on a circuit board 13.

The valve unit 1 expediently has a position sensor 14 for detecting the position of the valve member 6. The position sensor 14 is designed in particular to detect the position of the valve member 6 directly. As an example, the position sensor 14 is designed as a magnetic field sensor, for example as a Hall sensor. As an example, a magnet 15, whose magnetic field is detected by the magnetic field sensor, is arranged on the valve member 6, in particular on the closure section 9. By way of example, the position sensor 14 is arranged on the circuit board 13.

FIG. 2 shows a valve device 16. The valve device 16 comprises the valve unit 1. By way of example, the valve device 16 comprises a plurality of valve units 1, each of which is expediently designed like the valve unit 1 explained above. By way of example, the valve device 16 comprises four valve units 1, namely a first valve unit 1A, a second valve unit 1B, a third valve unit 1C and a fourth valve unit 1D. As an example, the valve units 1 are connected as a bridge, in particular as a full bridge. As an example, the first valve unit 1A and the second valve unit 1B together form a first half bridge. As an example, the third valve unit 1C and the fourth valve unit 1D together form a second half bridge.

By way of example, the valve device 16 comprises a fluid source 17, which is designed in particular as a pressurized air source. By way of example, the valve device 16 further comprises a fluid sink 18, which is designed in particular as a pressurized air sink.

Expediently, the valve device 16 has a first working outlet 19 and/or a second working outlet 20. The first valve unit 1A is fluidically connected between the fluid source 17 and the first working outlet 19, so that a fluidic connection between the fluid source 17 and the first working outlet 19 can selectively be established or interrupted via the first valve unit 1A. The second valve unit 1B is fluidically connected between the fluid sink 18 and the first working outlet 19, so that a fluidic connection between the fluid sink 18 and the first working outlet 19 can selectively be established or interrupted via the second valve unit 1B. The third valve unit 1C is fluidically connected between the fluid source 17 and the second working outlet 20, so that a fluidic connection between the fluid source 17 and the second working outlet 20 can selectively be established or interrupted via the third valve unit 1C. The fourth valve unit 1D is fluidically connected between the fluid sink 18 and the second working outlet 20, so that a fluidic connection between the fluid sink 18 and the second working outlet 20 can selectively be established or interrupted via the fourth valve unit 1D.

Expediently, the valve device 16 further has a fluidic actuator 21, which is designed, for example, as a fluidic drive, in particular as a pneumatic drive. For example, the fluidic actuator 21 is a in particular pneumatic drive cylinder or a in particular pneumatic valve actuator. The fluidic actuator 21 has, by way of example, a first pressure chamber 22 and preferably a second pressure chamber 23. The first pressure chamber 22 is, by way of example, fluidically connected to the first working outlet 19. For example, the first pressure chamber is connected to the first working outlet 19 via a first fluidic line 24, for example a first hose. By way of example, the second pressure chamber 23 is fluidically connected to the second working outlet 20. For example, the second pressure chamber is connected to the second working outlet 20 via a second fluidic line 25, for example a second hose.

By setting the first valve unit 1A to the open state (and expediently the second valve unit 1B to the closed state), pressurized fluid can be supplied to the first pressure chamber 22. By setting the second valve unit 1B to the open state (and expediently the first valve unit 1A to the closed state), pressurized fluid can be discharged from the first pressure chamber 22. By setting the third valve unit 1C to the open state (and, expediently, the fourth valve unit 1D to the closed state), pressurized fluid can be supplied to the second pressure chamber 23. By setting the fourth valve unit 1D to the open state (and expediently the third valve unit 1C to the closed state), pressurized fluid can be discharged from the first pressure chamber 22.

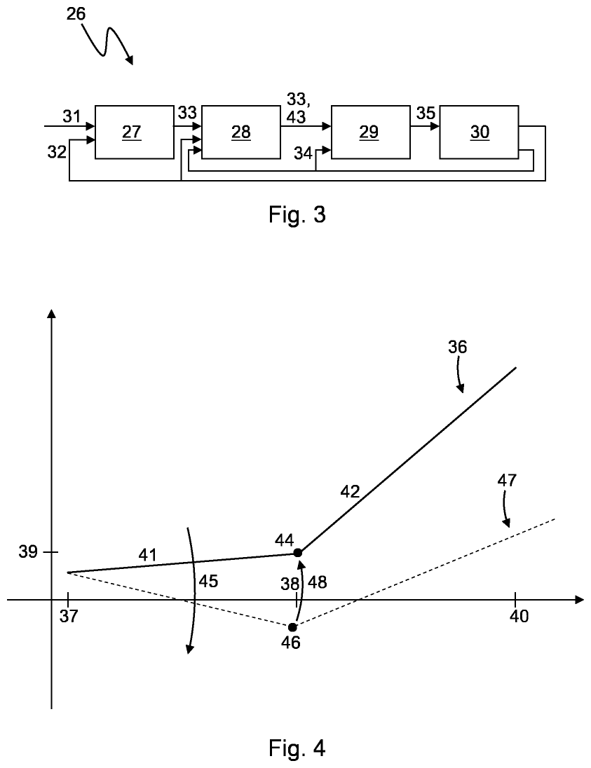

FIG. 3 shows a control loop 26, which comprises a position controller 27, an adaptation algorithm 28, a drive variable controller 29 and a controlled system 30. The drive variable controller 29 is an example of a voltage controller. Expediently, each valve unit 1 provides such a control loop 26. For example, each valve unit 1 provides a respective position controller 27, a respective adaptation algorithm 28 and/or a respective drive variable controller 29 on its computing unit 12. The position controller 27, the adaptation algorithm 28 and/or the drive variable controller 29 of each valve unit 1 are expediently implemented as software. Expediently, each valve unit 1 comprises a respective controlled system 30, which expediently comprises the respective valve member 6.

The following explanations apply expediently to each of the valve units 1—i.e. in particular to the respective control loop 26 of each valve unit 1.

The position controller 27 expediently receives a position setpoint signal 31, for example from a controller 50 of the valve device 16 (the controller 50 being in particular present in addition to the valve units 1). Furthermore, the position controller 27 receives a position actual value signal 32 (in particular determined using the position sensor 14), which represents the position of the valve member 6. On the basis of the position setpoint signal 31 and the position actual value signal 32, the position controller 27 calculates a drive variable setpoint signal 33, in particular in such a way as to cause the position actual value signal 32 to change towards the position setpoint signal 31. Preferably, the drive variable setpoint signal 33 is fed to the adaptation algorithm 28 and/or the drive variable controller 29. For example, the adaptation algorithm 28 forwards the drive variable setpoint signal 33 to the drive variable controller 29. Furthermore, the adaptation algorithm 28 can (in particular instead of the drive variable setpoint signal 33) feed a drive variable signal course signal 43 to the drive variable controller, in particular during an opening point determination procedure. The drive variable signal course signal 43 is in particular a drive variable ramp signal.

The drive variable controller 29 receives the drive variable setpoint signal 33 (or the drive variable signal course signal 43) and, expediently, a drive variable actual value signal 34 and expediently calculates a drive variable control value signal 35 for controlling the controlled system 30, in particular for controlling the valve member 6, in particular such that the drive variable actual value signal 34 changes towards the drive variable setpoint signal 33 (or the drive variable signal course signal 43). The drive variable setpoint signal 33 is, for example, a voltage setpoint signal, the drive variable actual value signal 34 is, for example, a voltage actual value signal, the drive variable signal course signal is, for example, a voltage signal curve signal and the drive variable control value signal is, for example, an electrical voltage signal with which the controlled system 30, in particular the valve member 6, is controlled. The voltage signal curve signal is, in particular, a voltage ramp signal.

As an example, the drive variable actual value signal 34 and/or the position actual value signal 32 is fed to the adaptation algorithm 28.

In the following, it will be explained in more detail how an opening point position value 39 (shown as an example in FIG. 4) can be determined for a valve unit 1 of the valve device 16. The following explanations apply expediently to each of the valve units 1 of the valve device 16. Expediently, the respective opening point position value is determined for each of the valve units 1 of the valve device in the manner explained below.

The opening point position value 39 describes the position of the valve member 6 of the valve unit 1 at which position the valve member 6 changes from the closed state to the open state. In particular, the opening point position value 39 describes the position of the valve member 6 at which, starting from the closed state, the fluid channel 3, in particular the sealing element opening 10, begins to open and/or a flow, in particular a mass flow, of a pressurized fluid through the fluid channel 3, in particular the sealing element opening 10, is established and/or begins to flow.

A drive variable, in particular an electrical voltage or pressure, is used to drive the valve member 6. The value of the drive variable at which the valve member 6 changes from the closed state to the open state is referred to as the drive variable opening value 38.

The opening point position value is determined in particular as part of an opening point determination procedure, which is preferably performed by each of the valve units 1, in particular by the respective adaptation algorithm 28. The respective opening point determination procedure is carried out in particular as explained below:

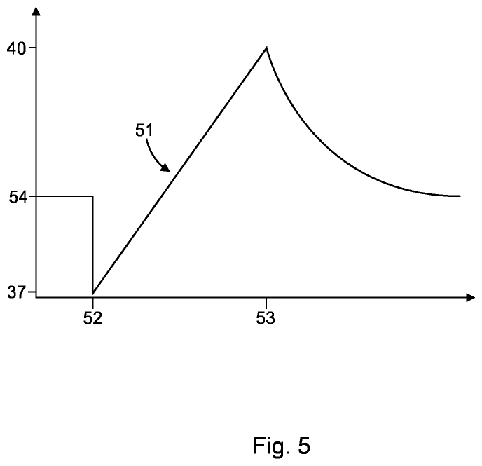

The valve device 16, in particular the valve unit 1 (for example the computing unit 12), provides a drive variable signal course 51 (shown in FIG. 5) to drive the valve member 6, so that the valve member 6 is moved from the closed state to the open state and/or from the open state to the closed state. The drive variable signal course 51 is a signal section (in particular temporal and/or predetermined in its signal curve) of the drive variable, which is provided in particular specifically for determining the opening point position value. The drive variable signal course can also be referred to as the drive variable signal section. The drive variable signal course 51 is, for example, increasing and/or decreasing, in particular monotonically increasing or monotonically decreasing. The drive variable signal course 51 is in particular a drive variable ramp. By way of example, the drive variable signal course 51 (in particular as the drive variable control value signal 35) is provided by the drive variable controller 29, in particular in response to the adaptation algorithm 28 feeding the drive variable signal course signal 43 to the drive variable controller 29.

FIG. 5 shows a time curve of the drive variable with the drive variable signal course 51. In the diagram shown in FIG. 5, time is plotted on the horizontal axis and the drive variable is plotted on the vertical axis. The drive variable signal course 51, in particular the drive variable ramp, is expediently a monotonically, in particular strictly monotonically, increasing section of the time curve of the drive variable. For example, the drive variable signal course, in particular the drive variable ramp, has the shape of a straight line with a positive slope. The drive variable signal course 51, in particular the drive variable ramp, expediently begins with an initial value 37 (exemplarily at a first point in time 52) and ends with an end value 40 (exemplarily at a second point in time 53). The drive variable signal course 51 is preferably a signal course of an electrical voltage. The drive variable ramp is preferably an electrical voltage ramp.

As an example, the initial value 37 of the drive variable signal course 51 is smaller than a value of the drive variable that is present immediately before the start (and/or after the end) of the drive variable signal course. In particular, the initial value 37 of the drive variable signal course 51 is smaller than a closed state value 54 of the drive variable which the valve unit 1 uses (in particular outside the opening point determination procedure, for example as part of an application) in order to set the valve member 6 to the closed state.

During the provision of the drive variable signal course 51, the valve device 16, in particular the valve unit 1 (for example the computing unit 12), records a position characteristic curve 36 (shown as an example in FIG. 4) of the valve member 6 as a function of the drive variable. By way of example, the adaptation algorithm 28 records the position characteristic curve 36, in particular on the basis of the actuator variable actual value signal 34 and/or the position actual value signal 32. For example, the adaptation algorithm records the position actual value signal 32 as a function of the actuator variable actual value signal 34 as the position characteristic curve 36.

To record the position characteristic curve 36, the valve device 16 detects the position of the valve member 6, preferably using the magnetic field sensor and the magnet 15 present on the valve member 6.

The valve device 16, in particular the valve unit 1 (exemplarily the computing unit 12) determines the opening point position value 39 on the basis of the recorded position characteristic curve 36. Exemplarily, the adaptation algorithm 28 calculates the opening point position value 39 on the basis of the recorded position characteristic curve 36.

FIG. 4 shows an exemplary position characteristic curve 36 of the valve member 6 as a function of the drive variable (for example an electrical voltage). The drive variable is plotted on the horizontal axis and the position of the valve member 6 is plotted on the vertical axis. The position characteristic curve 36 starts at the initial value 37 (the drive variable). The initial value 37 is, for example, an initial voltage value with which the valve member 6 is actuated at the start of the position characteristic curve 36. The position characteristic curve 36 comprises a first characteristic curve section 41, which is associated with a first movement phase of the valve member 6 (in particular represents this), in which first movement phase the valve member 6 is in the closed state. Preferably, the position characteristic curve 36 further comprises a second characteristic curve section 42, which is associated with a second movement phase of the valve member 6 (in particular represents this), in which second movement phase the valve member 6 is in the open state. The first characteristic curve section 41 starts at the initial value 37 and ends at the drive variable opening value 38. At the drive variable opening value 38, the valve member 6 assumes the opening position that corresponds to the opening point position value 39. The second characteristic curve section 42 starts at the actuator variable opening value 38 and ends at the end value 40 (the actuator variable).

The valve device 16 has the elastic sealing element 8, against which the valve member 6 rests in the closed state. Preferably, the valve member 6 is pressed into the elastic sealing element 8 by the initial value 37 of the drive variable signal course 51, so that during the provision of the drive variable signal course 51 the valve member 6 passes through the first movement phase, in which the valve member moves in the direction towards the open state, while the valve member continues to abut against the elastic sealing element and is in the closed state. During the provision of the drive variable signal course, the valve member 6 also passes through the second movement phase following the first movement phase, in which second movement phase the valve member 6 is in the open state.

As an example, the position characteristic curve 36 has a different slope for the first movement phase (i.e. in the first characteristic curve section 41) than for the second movement phase (i.e. in the second characteristic curve section 42). The slope of the first movement phase is, for example, the difference quotient of the first characteristic curve section 41 and the slope of the second movement phase is, for example, the difference quotient of the second characteristic curve section 42. By way of example, the slope of the position characteristic curve 36 is constant in the first movement phase and in the second movement phase. As an example, the slope of the position characteristic curve 36 in the first movement phase is smaller than the slope of the position characteristic curve 36 in the second movement phase. Exemplarily, the elastic sealing element 8 exerts a sealing element force (in particular caused by an elastic deformation of the sealing element 8) on the valve member 6 in the first movement phase (i.e. in the closed state). Expediently, the elastic sealing element 8 does not exert the sealing element force on the valve member 6 in the second movement phase (i.e. in the open state). Accordingly, different forces act on the valve member 6 in the first movement phase than in the second movement phase, so that the position of the valve member 6 in the first movement phase changes differently (in this example, less strongly) as a function of the drive variable than in the second movement phase.

In the first movement phase, the slope of the position characteristic curve 36 depends in particular on the stiffness of the sealing element 8 (in particular in the form of a sealing pad). The opening position 39 depends in particular on the force of the spring element 11 and a differential pressure acting on the valve member 6. In the second movement phase, the slope of the position characteristic curve 36 depends in particular on the stiffness of the valve member 6 and the spring element 11.

The transition from the first characteristic curve section 41 to the second characteristic curve section 42 is, by way of example, a kink 44—i.e. in particular a discontinuous point in the first derivative of the position characteristic curve 36 (with respect to the drive variable). Expediently, the valve device 16 (in particular the valve unit 1, preferably the adaptation algorithm 28) determines a position value of the valve member 6 at this kink 44 (i.e. in particular at the discontinuous point) as the opening point position value 39.

Preferably, the valve device 16 (in particular the valve unit 1, preferably the adaptation algorithm 28) performs a first rotation of the recorded position characteristic curve 36 by means of a mathematical operation (for example by a predetermined first angle) in order to obtain a rotated position characteristic curve 47. The mathematical operation is, for example, a multiplication of the position characteristic curve 36 by a rotation matrix. The first rotation is indicated by the arrow provided with the reference sign 45 in FIG. 4. Preferably, the valve device 16 (in particular the valve unit 1, preferably the adaptation algorithm 28) determines the opening point position value 39 by recognizing a minimum 46 of the rotated position characteristic curve 47.

Preferably, to determine the opening point position value 39, the valve device 16 (in particular the valve unit 1, preferably the adaptation algorithm 28) performs a second rotation of the minimum 46 opposite to the first rotation (for example by a predetermined second angle, the amount of which is expediently equal to the amount of the first angle). The second rotation is indicated by the arrow with the reference sign 48 in FIG. 4. Expediently, the valve device 16 (in particular the valve unit 1, preferably the adaptation algorithm 28) determines the position value of the valve member 6 at the minimum 46 rotated by the second rotation as the opening point position value 39. Optionally, the valve device 16 determines the value of the drive variable at the minimum 46 rotated by the second rotation as the actuator variable opening value 38.

The first angle and/or the second angle is preferably calculated in advance, for example based on how the stiffness effective for the valve member 6 changes from the first movement phase to the second movement phase. As an example, the position characteristic curve 36 is rotated during the first rotation such that the amount of the slope of the first characteristic curve section 41 is equal to the amount of the slope of the second characteristic curve section 42. Preferably, the valve device 16, in particular the adaptation algorithm 28, searches iteratively for the minimum 46 of the rotated position characteristic curve 47.

The opening point position value 39—i.e. the position value of the valve member 6 at the transition or kink 44 between the first characteristic curve section 41 and the second characteristic curve section—can also be found in another way, in particular without rotating the position characteristic curve 36. For example, the opening point position value 39 can be determined using a recursive determination of a reference straight line, in particular based on the fact that an error between the position characteristic curve 36 and the reference straight line increases significantly (for example exceeds a threshold value) as soon as the opening point position value 39 is traversed.

Expediently, the valve device 16, in particular the adaptation algorithm 28, terminates the opening point determination procedure in response to the fact that the opening point position value 39 has been determined. With the termination of the opening point determination procedure, the adaptation algorithm terminates the output of the drive variable signal course signal 43 and instead outputs the drive variable setpoint signal 33 (from the position controller 27) to the drive variable controller 29 again. For example, the valve device 16, in particular the valve unit 1, sets the drive variable to the closed state value 54 immediately after completion of the opening point determination procedure.

The valve device 16, in particular the adaptation algorithm 28, expediently stores the determined opening point position value 39, for example as the opening point variable. Preferably, the valve device 16 performs a position control of the valve member 6 using the opening point position value 39. For example, the valve device 16 uses the opening point position value 39 in the position control as a reference value, as an offset and/or for a calibration.

The valve device 16, in particular the adaptation algorithm 28, expediently compares the determined opening point position value 39 with a reference opening point (which was determined, for example, during a calibration of the respective valve unit 1). Preferably, the valve device 16, in particular the adaptation algorithm 28, stores the deviation between the determined opening point position value 39 and the reference opening point as a deviation value and expediently uses this deviation value in the position control.

Preferably, the valve device 16 provides the drive variable signal course 51 while the valve device 16 is executing an application. The application comprises, for example, the closed-loop position control of the valve unit 1 and/or a closed-loop control of the fluidic actuator 21, for example a closed-loop pressure control of the fluidic actuator and/or a closed-loop position control of an actuator member 49 (for example a piston) of the fluidic actuator 21. As an example, the valve device 16 has the controller 50, which executes the application. The controller 50 is exemplarily provided separately from the valve units 1 and is expediently communicatively connected to the valve units 1. In particular, the controller 50 provides a respective position setpoint signal 31 for each valve unit 1 as part of the application.

Preferably, the valve device 16, in particular the adaptation algorithm 28, checks whether one or more criteria for the opening point determination procedure are fulfilled and, in response thereto, starts the opening point determination procedure and, expediently, causes the drive variable signal course 51 to be provided. The criterion or the several criteria include, for example, that the valve unit 1 for which the opening point determination procedure is to be carried out is not currently required (in particular by the application) and/or does not currently have to assume the opening state (as part of the application).

Preferably, the valve device 16 provides the drive variable signal course 51 when the application specifies the closed state for the valve member 6. Expediently, the valve member 6 is set to the open state briefly enough when the drive variable signal course 51 is provided, so that the application (which at this time requires the closed state) is not impaired. Expediently, the valve device 16 sets the valve member 6 to the closed state immediately after completion of the drive variable signal course. For example, the adaptation algorithm 28 (in particular during the application) feeds the drive variable signal course signal 43 to the drive variable controller 29 instead of the drive variable setpoint signal 33 (in particular caused by the application). Expediently, the adaptation algorithm 28 feeds the drive variable setpoint signal 33 and no longer the drive variable signal course signal 43 to the drive variable controller 29 immediately after completion of the drive variable signal course.

By way of example, the valve device 16 comprises the first valve unit 1A and the second valve unit 1B (which is expediently designed in the same way as the first valve unit 1A). The second valve unit 1B is assigned to the same working outlet—exemplarily the first working outlet 19—as the first valve unit 1A. Expediently, the valve device 16 provides the drive variable signal course 51 (which causes the valve member 6 of the first valve unit 1A to move from the closed state to the open state) when the valve member of the second valve unit 1B is in the open state. For example, the valve device 16 provides the drive variable signal course 51 for the first valve unit 1A when pressurized fluid is discharged from the first working outlet via the second valve unit 1B (for example into the fluid sink 18). Expediently, the valve device 16 provides the drive variable signal course 51 (which causes the valve member 6 of the second valve unit 1B to move from the closed state to the open state) when the valve member of the first valve unit 1A is in the open state. For example, the valve device 16 provides the drive variable signal course 51 for the second valve unit 1B when pressurized fluid is supplied to the first working outlet 19 via the first valve unit 1A (for example, from the fluid source 17).

In particular, the valve device 16 detects that the first valve unit 1A is in the open state and, in response thereto, provides the drive variable signal course 51 for the second valve unit 1B and/or detects that the second valve unit 1B is in the open state and, in response thereto, provides the drive variable signal course 51 for the first valve unit 1A.

The first valve unit 1A and the second valve unit 1B are fluidically connected to the first pressure chamber 22 via the first working outlet 19. As an example, pressurized fluid is admitted into the first pressure chamber 22 via the first valve unit 1A and pressurized fluid is discharged from the first pressure chamber 22 via the second valve unit 1B. According to an alternative embodiment, pressurized air is released from the first pressure chamber via the first valve unit and pressurized air is admitted into the first pressure chamber via the second valve unit.

In the application, for example, a pressure in a volume—for example the first pressure chamber 22—is closed-loop controlled. For this purpose, for example, the first valve unit 1A acts as a aeration valve and the second valve unit 1B acts as a de-aeration valve. Expediently, at any time, only one of the two valve units 1A, 1B—i.e. either the first valve unit 1A or the second valve unit 1B—is in the open position for the application and the other valve unit is in the closed position. Preferably, the valve device 16 carries out the respective opening point determination procedure for the valve unit 1 that is currently in the closed position.

We claim:

1. A method for determining an opening point position value of a valve device with a valve unit, wherein the opening point position value describes the position of a valve member of the valve unit at which position the valve member changes from a closed state to an open state, wherein the method comprises the steps:
providing a drive variable signal course, in order to drive the valve member with a drive variable, in particular an electrical voltage or a pressure, so that the valve member is moved from the closed state to the open state and/or from the open state to the closed state,
during the providing of the drive variable signal course, recording a position characteristic curve of the valve member as a function of the drive variable,
on the basis of the recorded position characteristic curve, determining the opening point position value.

2. The method according to claim 1, wherein the valve device has an elastic sealing element against which the valve member abuts in the closed state, and wherein the valve member is pressed into the elastic sealing element by an initial value of the drive variable signal course, so that the valve member undergoes a first movement phase during the providing of the drive variable signal course, in which first movement phase the valve member moves towards the open state, while the valve member continues to abut against the elastic sealing element and is in the closed state, and a second movement phase following the first movement phase, in which second movement phase the valve member is in the open state.

3. The method according to claim 2, wherein the position characteristic curve has a first characteristic curve section which is associated with the first movement phase and a second characteristic curve section which is associated with the second movement phase, and the valve device determines, as the opening point position value, a position value of the valve member at a kink between the first characteristic curve section and the second characteristic curve section.

4. The method according to claim 2, wherein the valve device performs a first rotation of the recorded position characteristic curve by means of a mathematical operation to obtain a rotated position characteristic curve, and determines the opening point position value by recognizing a minimum of the rotated position characteristic curve.

5. The method according to claim 4, wherein the valve device performs a second rotation of the minimum to determine the opening point position value, wherein the second rotation is in opposite direction to the first rotation.

6. The method according to claim 1, wherein the valve device performs a closed-loop position control of the valve member using the opening point position value.

7. The method according to claim 1, wherein the drive variable signal course is provided while the valve device is executing an application, wherein the drive variable signal course is provided when the application specifies the closed state for the valve member.

8. The method according to claim 1, wherein the valve unit is a first valve unit and the valve device comprises a second valve unit associated with the same working outlet as the first valve unit, and the valve device provides the drive variable curve for the first valve unit when a valve member of the second valve unit is in an open state.

9. The method according to claim 8, wherein the first valve unit and the second valve unit are pneumatically connected to a pressure chamber via the working outlet, and wherein pressurized fluid is admitted into the pressure chamber via the first valve unit and pressurized fluid is discharged from the pressure chamber via the second valve unit, or wherein pressurized fluid is discharged from the pressure chamber via the first valve unit and pressurized fluid is admitted into the pressure chamber via the second valve unit.

10. The method according to claim 1, wherein the valve device for recording the position characteristic curve detects the position of the valve member using a magnetic field sensor and a magnet present on the valve member.

11. The method according to claim 1, wherein the valve unit is a piezo valve unit.

12. The method according to claim 1, wherein the drive variable signal course is a drive variable ramp.

13. The method according to claim 1, wherein the drive variable is an electrical voltage or a pressure.

14. A valve device having a valve unit, which has a valve member which can be moved from a closed state into an open state by means of a drive variable, the valve device being configured to provide a drive variable signal course in order to drive the valve member, so that the valve member is moved from the closed state into the open state and/or from the open state into the closed state, record, during the provision of the drive variable signal course, a position characteristic curve of the valve member as a function of the drive variable and determine an opening point position value on the basis of the recorded position characteristic curve, the opening point position value describing the position of the valve member at which position the valve member changes from the closed state to the open state.
